(19) United States
(12) Patent Application Publication
(10) Pub. No.: US 2016/0075837 A1
(43) Pub. Date: Mar. 17, 2016

(54) METHOD FOR REMOVING BUBBLES IN POLYIMIDE SOLUTION

(71) Applicant: EverDisplay Optronics (Shanghai) Limited, Shanghai City (CN)

(72) Inventors: Jiahao LU, Shanghai City (CN); Hao KOU, Shanghai City (CN); Pengtao KANG, Shanghai City (CN)

(21) Appl. No.: 14/802,665

(22) Filed: Jul. 17, 2015

(30) Foreign Application Priority Data
Sep. 17, 2014 (CN) 201410475032.7

(51) Int. Cl. C08J 3/28

(52) U.S. Cl. CPC C08J 3/28; C08J 2379/08

(57) ABSTRACT

The present disclosure provides a method for removing bubbles in polyimide solution, including: putting the polyimide solution in an open container; and emitting microwaves to the polyimide solution using a microwave generator to perform a microwave treatment lasting a time period so as to remove the bubbles in the polyimide solution. Using the method of the present disclosure to process polyimide solution may conveniently and quickly remove the bubbles in the polyimide solution. This greatly reduces the time required by the process and thus may meet industrialization demands. Meanwhile, the method effectively reduces the volatilization of an organic solvent having a low melting point in the polyimide solution, thereby maintaining proportion stability of the polyimide solution and avoiding defects generated in subsequent coating processes.

This application is based upon and claims priority to Chinese Patent Application No. 201410475032.7, filed on Sep. 17, 2014, the entire contents of which are incorporated herein by reference.

### TECHNICAL FIELD

The present disclosure relates to a method for processing polyimide, and more particularly, to a method for removing bubbles in polyimide solution.

### BACKGROUND

Polyimide refers to polymers that contain an imide ring (—CO—NH—CO—) on the backbone thereof, among which a polymer containing a phthalimide structure is the most important. Serving as a special engineering material, polyimide enjoys diverse applications in many fields such as aviation, aerospace, micro-electronics, nanometer, liquid crystal, separating membrane, laser and the like. In the 1960's, study, development and utilization of polyimide, as one of the most promising engineering plastics in the twenty-first century, were made by all countries. Due to its outstanding characteristics in properties and synthesis aspects, the huge application prospect of polyimide, both as a structural material or a functional material, has been sufficiently recognized. Thus, polyimide is called as a “problem solver”, and it is deemed that “without polyimide, there would be no microelectronic technology today”.

At present, flexible active matrix organic light emitting diode (Flexible AMOLED) devices are developed and produced mainly based on polyimide. Usually, polyimide (PI) liquid is coated on a glass substrate via a slit coat manner or a spin coat manner and then is dried and baked. FIG. 1 is a block diagram showing a polyimide coating device in related arts. The coating device usually includes a coating system 102, a cleaning system 103, and a liquid feeding system 104. Polyimide (PI) is stored in the liquid feeding system 104 in a solution form. During application, the polyimide (PI) solution is transferred from the liquid feeding system 104 into the coating system 102 under the effect of a pump 105, and is coated on a surface of a glass substrate 101.

The existing polyimide solution usually contains a large number of micron-sized bubbles which cannot be effectively excluded during and after coating. In subsequent drying and baking stages, these bubbles will disperse on the surface of polyimide to form pores of certain size (for example, 1˜4 μm). As shown in FIG. 2, these bubbles will fall off in subsequent processes, as shown in FIG. 3, thus severely affecting the stability of subsequent processes.

A normal method for removing bubbles in polyimide solution at present is to allow the polyimide solution to stand in a vacuum environment for a long period (for example, 36˜72 hours) with evacuation performed all the time. However, such method has many deficiencies. On one hand, it takes a relatively long time period and thus cannot meet the demands of industrialization mass production. On the other hand, performing evacuation all the time is easy to cause volatilization of an organic solvent having a low melting point (for example, N-methyl pyrrolidone and the like) in the polyimide solution and thereby make the proportion of the polyimide solution deviate from primordial compositions. Consequently, defects may be generated in subsequent coating processes.

### SUMMARY OF THE INVENTION

The present disclosure provides a method for removing bubbles in polyimide solution, which is faster and more efficiently.

The present disclosure provides a method for removing bubbles in polyimide solution, including:

putting the polyimide solution in an open container; and

emitting microwaves to the polyimide solution using a microwave generator to perform a microwave treatment lasting a time period so as to remove the bubbles in the polyimide solution.

In an embodiment of the method according to the present disclosure, the microwave treatment includes: increasing temperature of the polyimide solution using the microwaves to make the bubbles in the polyimide solution rise up to a surface of the polyimide solution and collapse.

In another embodiment of the method according to the disclosure, frequency of the microwaves is 2200˜2800 MHz.

In another embodiment of the method according to the disclosure, frequency of the microwaves is 2450 MHz.

In another embodiment of the method according to the disclosure, the time period for the microwave generator emitting the microwaves is 5˜10 minutes.

In another embodiment of the method according to the disclosure, the power of the microwaves emitted by the microwave generator is 800˜1000 W.

In another embodiment of the method according to the disclosure, a frequency of the microwaves is in negative correlation with the time period of the microwave treatment.

In another embodiment of the method according to the disclosure, the open container has an upward opening and a base plate opposite to the opening, and the microwave generator is disposed below the base plate of the container.

In another embodiment of the method according to the disclosure, the base plate of the container is made of a material that allows microwaves to penetrate.

In another embodiment of the method according to the disclosure, the material of the base plate comprises any one of glass, plastic and ceramic.

Using the method of the present disclosure to process polyimide solution may conveniently and quickly remove the bubbles in the polyimide solution. This greatly reduces the time required by the process and thus may meet industrialization demands. Meanwhile, the method effectively reduces the volatilization of an organic solvent having a low melting point in the polyimide solution, thereby maintaining proportion stability of the polyimide solution and avoiding defects generated in subsequent coating processes.

### BRIEF DESCRIPTION OF THE DRAWINGS

FIG. 1 is a block diagram showing a polyimide coating device in related arts;

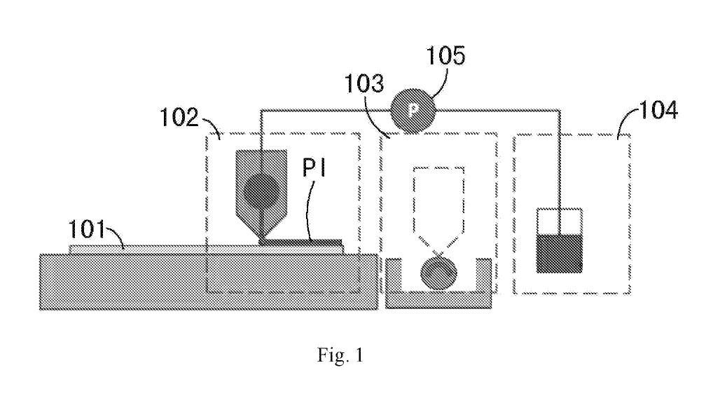

FIG. 2 shows pores formed by dispersing of bubbles towards a surface of polyimide during drying and baking stages;

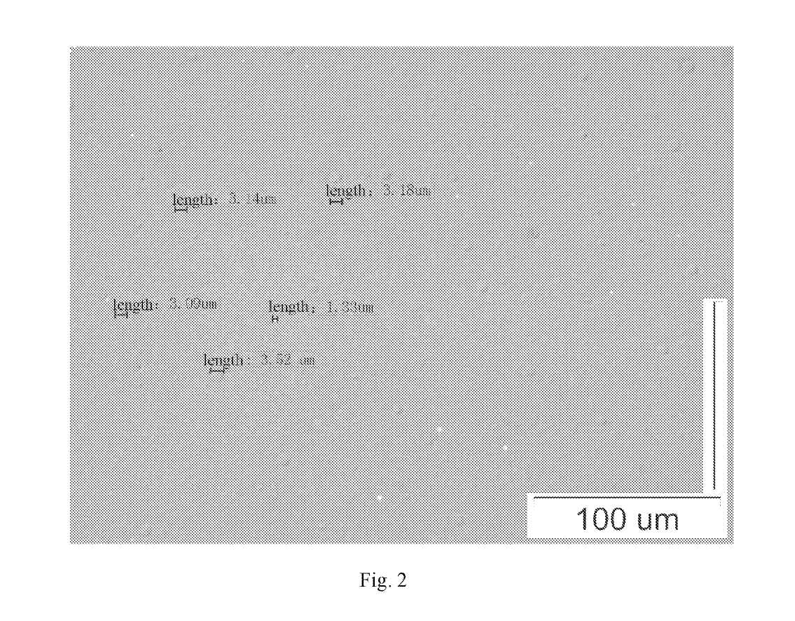

FIG. 3 shows a falling off phenomenon caused by the bubbles in polyimide;

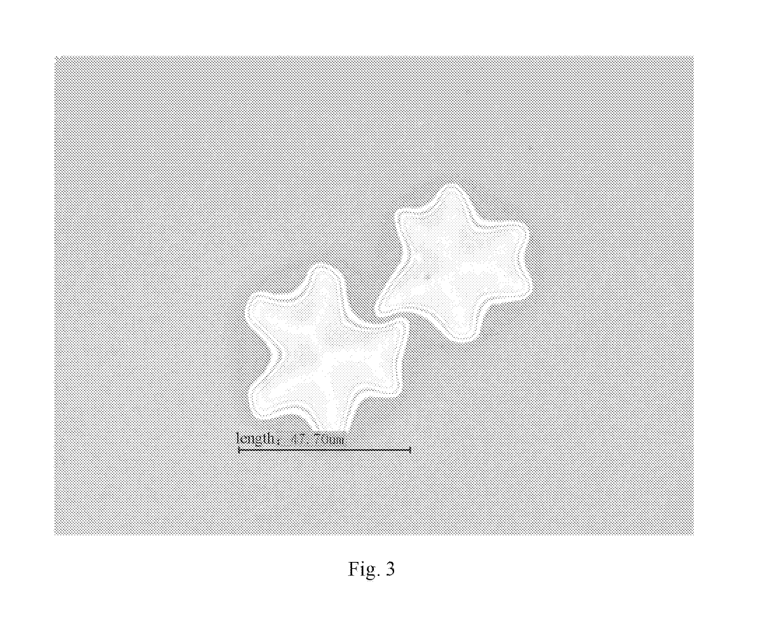

FIG. 4 is a block diagram showing a principle of removing the bubbles in polyimide according to the method of the present disclosure;

FIG. 5 is a block diagram showing a principle of removing the bubbles in polyimide according to the method of the present disclosure;

FIG. 6 is a block diagram showing a principle of removing the bubbles in polyimide according to the method of the present disclosure;

FIG. 7 is a block diagram showing coating effect of polyimide subject to microwave treatment for three minutes;

FIG. 8 is a block diagram showing the coating effect of polyimide subject to microwave treatment for five minutes;

FIG. 9 is a block diagram showing the coating effect of polyimide subject to microwave treatment for seven minutes; and

FIG. 10 is a block diagram showing the coating effect of polyimide subject to microwave treatment for ten minutes.

Reference characters used herein are listed as follows:
101: glass substrate
102: coating system
103: cleaning system
104: liquid feeding system
105: pump
PI: polyimide
201: open container
202: polyimide
203: bubble
204: base plate of the container
205: microwave generator

### DETAILED DESCRIPTION OF THE INVENTION AND PREFERRED EMBODIMENTS

The technical solution of the present disclosure will be further described hereinafter according to specific embodiments. The protection scope of the present disclosure is not limited to the following embodiments, and these embodiments enumerated are only for the purposes of illustration but not for limiting the present disclosure in any manner.

The present disclosure provides a method for removing bubbles in polyimide solution, including: putting the polyimide solution in an open container; and emitting microwaves to the polyimide solution using a microwave generator to perform a microwave treatment lasting a time period so as to remove the bubbles in the polyimide solution.

Currently, the polyimide solution applied in the field of flexible organic light emitting diodes usually contains 18˜26 vol % (percent by volume) polyimide, 10˜20 vol % organic solvents and the like, wherein the organic solvents mainly include NMP (N-methyl pyrrolidone) and dipropylene glycol dimethyl ether and the like. The NMP is an organic solvent having a low melting point and relatively high volatility. The method of the present disclosure is applicable in polyimide solution including any composition and of any proportion, and is not limited to the above solution compositions.

Microwave is a, high frequency electromagnetic wave which has obvious characteristics such as a wavelength ranging from 1 mm to 1 m, a frequency ranging from 300 MHz to 300 GHz, quantum properties, and the like. The microwave technology is widely applied in aspects such as radar, navigation, multiple access communication, remote sensing, television, and the like.

The basic properties of the microwave are usually presented as penetration, reflection and absorption. For glass, plastic and ceramic, the microwave can penetrate with nearly no absorption. For water and food and the like, the microwave will be absorbed so that the water and food will be heated. And, for metals and the same, the microwave will be reflected.

When the microwave permeates into a medium, certain interaction can occur between the microwave and the medium. Taking the microwave having a frequency of 2450 MHz as an example, such microwave enables molecules of the medium to vibrate for 2.45 billion times per second, friction is generated mutually between the molecules of the medium, and thus the temperature of the medium is increased. Consequently, the interior and the exterior of the medium material are heated almost at the same time to form a body heat source state. In this way, the heat conduction time is greatly shortened as compared with regular heating, and the interior and the exterior of the material are heated uniformly and consistently in case that the loss factor of the medium is in negative correlation with the temperature of the medium.

The microwave treatment of the present disclosure is as follows: microwaves are emitted into the polyimide solution through the microwave generator, the microwaves and the polyimide solution interact with each other so that the temperature of the polyimide solution is increased and the temperature of the air in the bubbles in the polyimide solution are also increased, thus driving the bubbles to rise up to the surface of the polyimide solution and collapse so as to achieve the effect of bubbles removal.

Taking the heating degree and penetration depth of the microwaves into consideration, the frequency of the microwaves used in the present disclosure may be 2200˜2800 MHz, for example. According to an example, the frequency may be 2450 MHz.

The time period for the microwave generator emitting microwaves to perform a microwave treatment on the polyimide solution is 5˜10 minutes. Too short time will cause incomplete removal of the bubbles, while too long time will cause over increased temperature of the polyimide solution, which may cause a number of organic solvents having a low melting point in the polyimide solution to volatilize and thereby make the proportion of the solution deviate from primordial compositions and then cause coating defects.

The power of the microwaves emitted by the microwave generator may be 800˜1000 W, for example. The larger the power of the emitter is, the shorter the treatment time will be and better effects may be achieved. However, an excessively high power may cause a narrowed process window.

In the present disclosure, the frequency of the microwaves is in negative correlation with the time period of the microwave treatment. That is, when the frequency of the microwaves is relatively high, the molecules of the medium vibrate more quickly, and the medium is warmed up faster. Thus, the time of the microwave treatment should be reduced so as to avoid deviation of the proportion of the solution caused by the excessive warming up. On the contrary, when the frequency of the microwaves is relatively low, the molecules of the medium vibrate relatively low, and the medium is warmed up more slowly, too. Thus, the time of the microwave treatment should be properly prolonged.

Using the microwave generator to process the polyimide solution may be performed through the following manners, but the present disclosure is not limited to these manners.

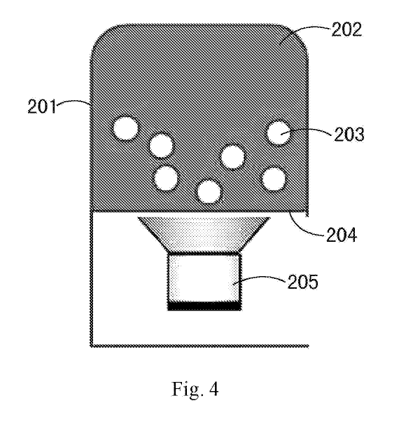

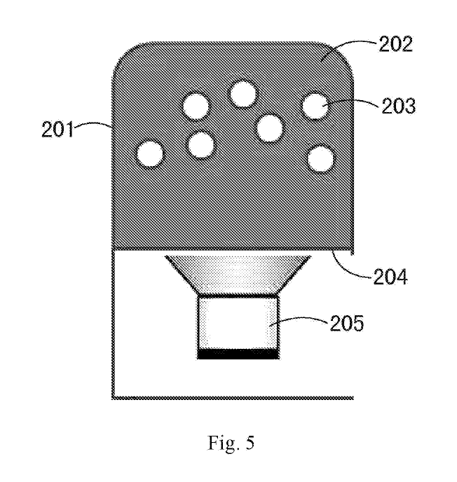

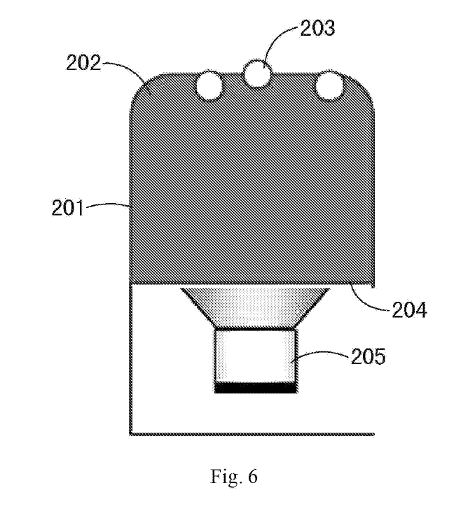

As shown in FIGS. 4 to 6, an open container 201 has an upward opening and a base plate 204 opposite to the opening, and a microwave generator 205 may be disposed below the base plate 204 of the container 201 so as to perform the microwave treatment on polyimide solution 202 in the open container 201.

The microwaves emitted by the microwave generator 205 functions in the polyimide solution 202 to make the temperature of the polyimide solution 202 increase, and the bubbles 203 in the polyimide solution 202 gradually rise up and finally reach the surface of the polyimide solution 202 and collapse, thus achieving the effect of removal of bubbles 203.

In order to make the microwave smoothly arrive at the polyimide solution from the microwave generator, the base plate of the container may usually be made of a material that allows microwaves to penetrate, for example, glass, plastic or ceramic and the like.

Unless otherwise specified, all the terms used herein have the meanings understood by those skilled in the art.

The present disclosure will be further described in details hereinafter by the following embodiments.

### Example 1

A polyimide solution is put in an open container. The open container has an upward opening and a base plate opposite to the opening, and the base plate of the container is made of glass, plastic or ceramic.

A microwave generator is disposed below the base plate of the container, and microwaves having a frequency of 2450 MHz are emitted by the microwave generator to the polyimide solution to perform a microwave treatment lasting three minutes so as to remove the bubbles in the polyimide solution. The power of the microwave generator is 1000 W.

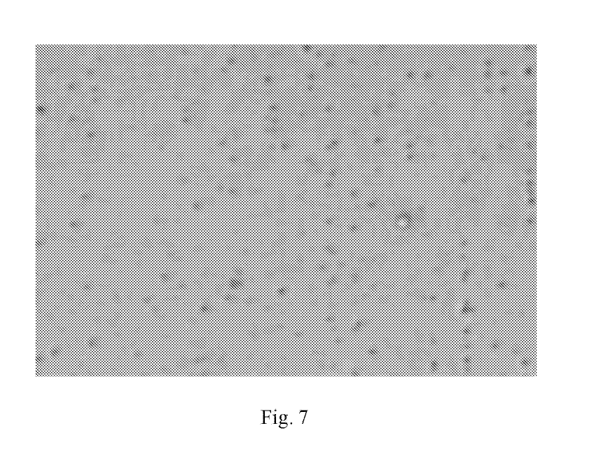

The polyimide solution subject to the foregoing bubble removal treatment is coated and dried, and the obtained result is shown in FIG. 7.

### Example 2

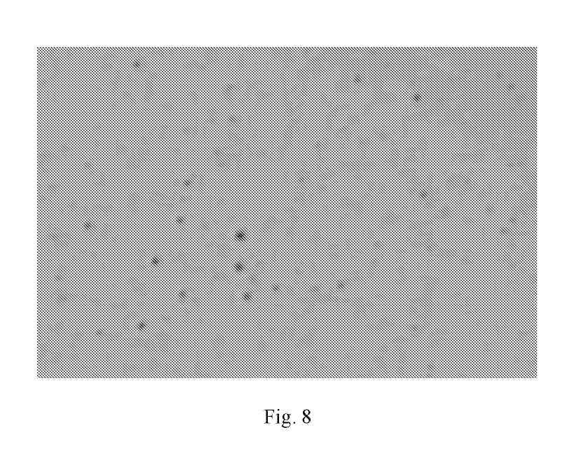

The treatment of the polyimide solution is identical to that of the first embodiment except for the difference that the time period of the microwave treatment is five minutes. The coating effect of the resulted polyimide solution is as shown in FIG. 8.

### Example 3

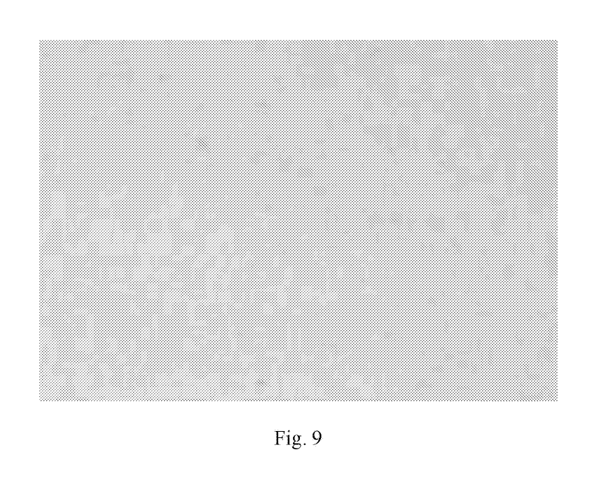

The treatment of the polyimide solution is identical to that of the first embodiment except for the difference that the time period of the microwave treatment is seven minutes. The coating effect of the resulted polyimide solution is as shown in FIG. 9.

### Example 4

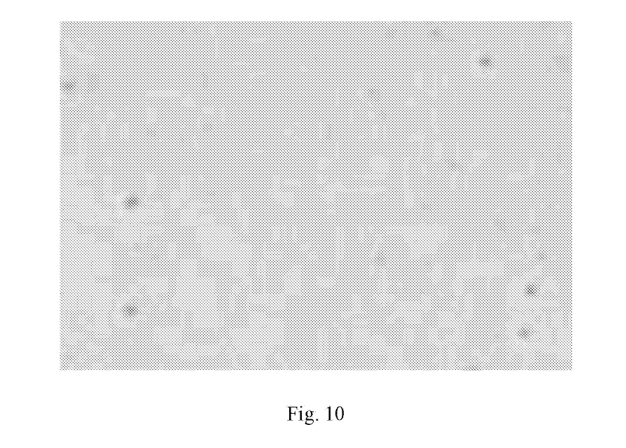

The treatment of the polyimide solution is identical to that of the first embodiment except for the difference that the time period of the microwave treatment is ten minutes. The coating effect of the resulted polyimide solution is as shown in FIG. 10.

It can be seen from FIGS. 7 to 10 that, the polyimide solution subject to the microwave treatment for three minutes still has more bubbles after being coated, which illustrates that the treatment time is too short and the bubbles are incompletely removed. However, the polyimide solution subject to the microwave treatment for ten minutes has more defects after being coated, which illustrates that: the treatment time is too long, and such treatment time causes the polyimide solution to be excessively warmed up, and this results in volatilization of the organic solvents having a low melting point in the polyimide solution and the deviation of the proportion of the solution from primordial compositions and thereby coating defects. The polyimide solution subject to the microwave treatment for five minutes and seven minutes form more smooth surfaces after being coated, and the coating effect of the polyimide solution subject to microwave treatment for seven minutes is more excellent.

In conclusion, using the method of the present disclosure to process polyimide solution may conveniently and quickly remove the bubbles in the polyimide solution. This greatly reduces the time required by the process and thus meets industrialization demands. Meanwhile, the method effectively reduces the volatilization of an organic solvent having a low melting point in the polyimide solution, thereby maintaining proportion stability of the polyimide solution and avoiding defects generated in subsequent coating processes.

It should be noted that embodiments described herein are exemplary only, and those skilled in the art may make various substitutions, modifications and improvements within the scope of the present disclosure. Therefore, the present disclosure is not limited to the foregoing embodiments, but shall be defined by the appending claims only.

What is claimed is:

1. A method for removing bubbles in polyimide solution, comprising:
putting the polyimide solution in an open container; and
emitting microwaves to the polyimide solution using a microwave generator to perform a microwave treatment lasting a time period so as to remove the bubbles in the polyimide solution.

2. The method according to claim 1, wherein the microwave treatment comprises:
increasing temperature of the polyimide solution using the microwaves to make the bubbles in the polyimide solution rise up to a surface of the polyimide solution and collapse.

3. The method according to claim 1, wherein frequency of the microwaves is 2200˜2800 MHz.

4. The method according to claim 3, wherein the frequency of the microwaves is frequency of 2450 MHz.

5. The method according to claim 1, wherein the time period for the microwave generator emitting the microwaves is 5˜10 minutes.

6. The method according to claim 4, wherein the time period for the microwave generator emitting the microwaves is 5˜10 minutes.

7. The method according to claim 1, wherein power of the microwaves emitted by the microwave generator is 800˜1000 W.

8. The method according to claim 4, wherein power of the microwaves emitted by the microwave generator is 800˜1000 W.

9. The method according to claim 1, wherein a frequency of the microwaves is in negative correlation with the time period of the microwave treatment.

10. The method according to claim 1, wherein the open container has an upward opening and a base plate opposite to the opening, and the microwave generator is disposed below the base plate of the container.

11. The method according to claim 10, wherein the base plate of the container is made of a material that allows microwaves to penetrate.

12. The method according to claim 11, wherein the material of the base plate comprises any one of glass, plastic and ceramic.

13. The method according to claim 6, wherein the power of the microwaves emitted by the microwave generator is 800˜1000 W.

14. The method according to claim 2, wherein frequency of the microwaves is 2200˜2800 MHz.

15. The method according to claim 14, wherein frequency of the microwaves is 2450 MHz.

16. The method according to claim 2, wherein a frequency of the microwaves is in negative correlation with the time period of the microwave treatment.

17. The method according to claim 2, wherein the open container has an upward opening and a base plate opposite to the opening, and the microwave generator is disposed below the base plate of the container.

18. The method according to claim 17, wherein the base plate of the container is made of a material that allows microwaves to penetrate.

19. The method according to claim 18, wherein the material of the base plate comprises any one of glass, plastic and ceramic.

20. The method according to claim 2, wherein the time period for the microwave generator emitting the microwaves is 5˜10 minutes.
